(19) United States
(12) Patent Application Publication
(10) Pub. No.: US 2002/0100348 A1
(43) Pub. Date: Aug. 1, 2002

(54) Tabletop cake slicer

(76) Inventor: Scott Edward Hogan, Everett, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/021,304

(22) Filed: Oct. 22, 2001

Related U.S. Application Data
(60) Provisional application No. 60/242,221, filed on Oct. 20, 2000.

(51) Int. Cl. B26D 1/00; B26D 7/00

(52) U.S. Cl. 83/13; 83/758; 83/783

(57) ABSTRACT

A cake slicer that, during operation, cuts in a truly linear fashion and efficiently transfers loads generated in the saw blade from the blade to the base. The cake slicer includes a rigid saw blade assembly that linearly reciprocates between two bearing blocks. The saw blade assembly includes a blade tensioning assembly that helps retain the saw blade to the frame of the blade assembly and allows one to adjust the tension of the saw blade. The cake slicer also includes a coupler to connect the rigid saw blade assembly to a motor. The Coupler includes a half coupling with drive pins and a drive pulley with drive-pin recesses that receive the drive pin. The cake slicer also includes a plurality of weighted rollers to prevent unintended elevation or declination of the cakes during operation.

### FIELD OF THE INVENTION

The present invention pertains to an automated tabletop cake slicer, and more particularly to such a unit employing a rigid saw blade assembly supported by linear bearings thereby ensuring true linear translation and cutting consistency.

### BACKGROUND OF THE INVENTION

Present automated tabletop cake slicers rely upon a pivoting lever arm arrangement whereby a saw blade links the lower portions of a pair of supported lever arms and a tensioning configuration links the upper portions of the pair of lever arms. The point of pivot is set between the two linking locations. While accomplishing the desired objective of causing reciprocation of the attached saw blade when at least one lever arm is pivoted, this design suffers from several deficiencies.

One deficiency relates to the nature of the lever arm attachments. In particular, this configuration, which is illustrated in FIG. 5, causes high loads to form at each pivot location due principally to the tensioning requirements for retaining the saw blade in the assembly. In addition to these inherent forces, lateral or off axis loads are disadvantageously transferred to the pivot point of the saw blade during cutting operations. Consequently, binding is likely to occur between the supporting structure and the lever arm unless a non-radial bearing (e.g., thrust bearing) is employed.

Another deficiency relates to the means employed in the prior art to achieve tensioning adjustment of the saw blade. As shown in FIG. 5, a turnbuckle means is used. This design fails to provide desired rigidity to the assembly nor an ability to use a single tool to perform tensioning adjustment, i.e., a user must both manipulate the turnbuckle and retain the connecting members stationary.

As will be described in detail below, the present invention is intended to advance the state of the art and eliminate these and other deficiencies.

### SUMMARY OF THE INVENTION

The improved tabletop cake slicer comprises a generally horizontal base to which is rigidly mounted a first and a second bearing block wherein the bearing blocks are separated from each other by a distance. Each bearing block has a receiving means to accept a portion of a linearly reciprocating saw blade assembly. The saw blade assembly comprises a rigid frame having a spanning or web portion and two, opposing leg portions, a saw blade linking the two opposing leg portions, and at least two bearing block engaging members. A motor is operatively linked to the saw blade assembly to provide reciprocation of the assembly relative to the horizontal base.

A feature of the invention relates to the incorporation of a rigid saw blade assembly, unlike apparatus of the prior art wherein a pivotally linked saw blade arrangement is used. Because a pivoting mounting configuration is not used, it is therefore necessary to mount the assembly in a pair of bearing blocks so as to limit saw blade motion to linear reciprocation. The means for achieving this objective are varied. In a preferred embodiment, one or more bores are formed in each bearing block and a corresponding number of bearing shafts are disposed in the saw blade assembly. Alternatively, bearing shafts can be disposed in the bearing blocks with complementary bores formed in the saw blade assembly. Notwithstanding the foregoing, each bearing block may be formed to receive a portion of the saw blade assembly without having to incorporate auxiliary components such as bearing shafts. In such an instance, the bearing blocks may have a simple “U” shape wherein the leg portions of the saw blade assembly are received and supported therein. As still another alternative, the saw blade assembly might be supported by a pair of pivoting arms, although the motion of the saw blade assembly would not be truly linear.

Another feature of the invention relates to a means for adjusting the tension of the saw blade within the saw blade assembly. Prior art inventions utilized a turnbuckle assembly wherein the distance between the upper portions of the pivoting lever arms was shortened in order to increase tension of the saw blade that was linking the two lower portions of the pivoting lever arms. In the present invention, tension in the blade is preferably modified at a single point, namely at one of the leg portions of the saw blade assembly.

Yet another feature of the invention relates to the coupling arrangement between the motor and the saw assembly. In a preferred embodiment of the invention, a removable half coupling is employed. Two or more pins extend from a driven pulley to engage two or more pin recesses formed in the half coupling, which in turn drives a flywheel that imparts motion to a connecting rod linked to the saw assembly. Preferably, there are no retaining elements to ensure connection between the driven pulley and the half coupling. Instead, the physical proximity of the two components ensures proper power distribution. Alternatively, motive force from the motor can be directly applied, as opposed to via a pulley arrangement, to the half coupling.

Still another feature of the invention relates to the user of weight-biased rollers for counteracting any lift of the cake or other food item subject to cutting. Advantageously, the rollers are mounted to the inside surface of a cover, thus providing convenient and safe means for substituting rollers of different dimensions and weight. Moreover, the use of weight-biased rollers eliminates complexities and sanitary issues relating to spring-biased rollers used in the prior art.

### BRIEF DESCRIPTION OF THE DRAWINGS

FIG. 1 is a perspective view of a tabletop cake slicer illustrating the basic assemblies thereof;

FIG. 2 is an exploded partial perspective view of the motor and drive linkage of the slicer;

FIG. 3 is a detailed partial perspective view of an adjustment assembly used to modify tension of the saw blade;

FIG. 4 is a detailed partial perspective view of a motor to drive linkage coupling arrangement for imparting motive force to the saw assembly; and

FIG. 5 is a perspective view of a prior art cake slicer.

### DETAILED DESCRIPTION OF THE INVENTION

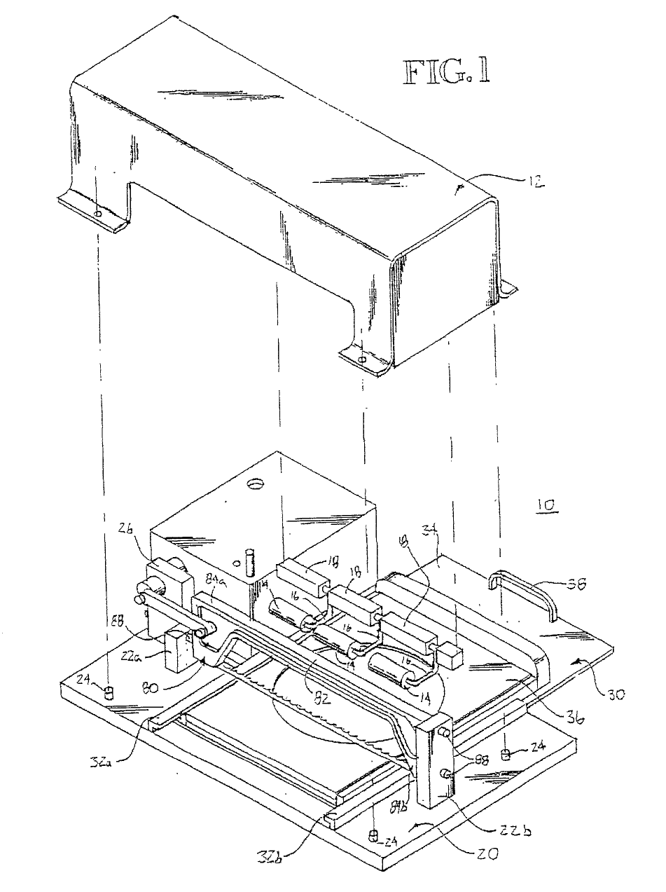

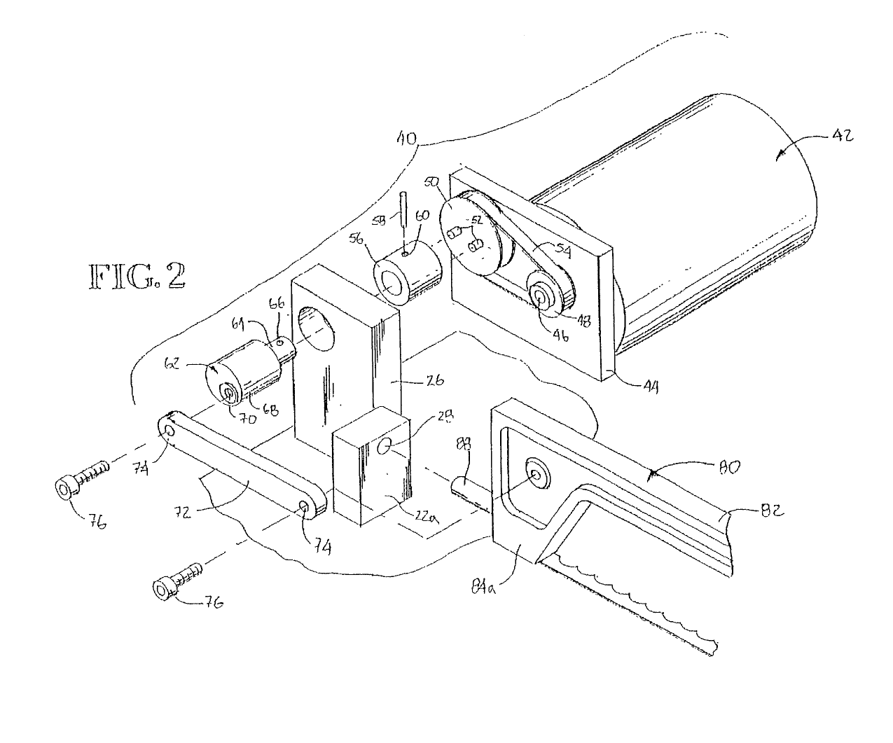

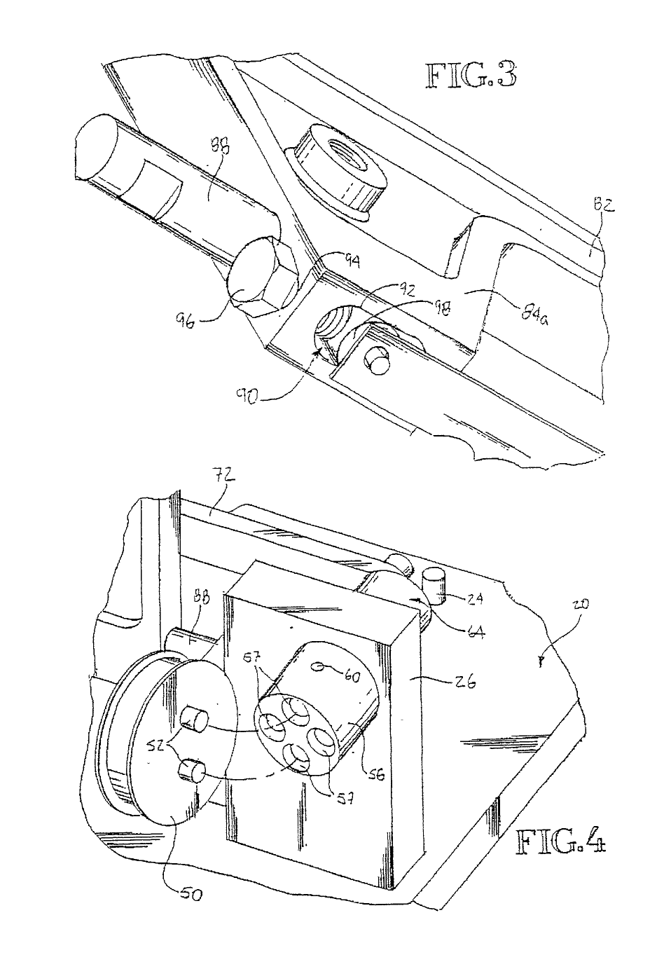

Referring then to the several figures where in like numerals indicate like parts and more particularly to FIG. 1, the components of cake slicer 10 are shown. Cake slicer 10 includes base assembly 20, tray assembly 30, drive assembly 40 (see FIG. 2), saw assembly 80, and blade tensioner 90 (see FIG. 3). All components of cake slicer 10 are preferably formed from food grade material, e.g., stainless steel and polyethylene.

Base assembly 20 includes bearing blocks 22a and 22b (each defining bores 28 such as shown in FIG. 2), location pins 24, and bearing block 26. As shown clearly in FIG. 1, bearing blocks 22a and 22b, which are preferably constructed of an ultra high molecular weight plastic, provide the necessary support for saw assembly 80. Location pins 24 provide registry assistance for cover 12. Bearing block 26 provides the necessary radial support and location for the drive components of drive assembly 40, while bores 28 facilitate low friction translation of saw assembly 80. Both bearing blocks 22a and 22b, as well as bearing block 26, are rigidly affixed to the base through a traditional fastening means. It is only necessary to establish a mechanical ground so that forces presented to these blocks either by motor 42 or saw assembly 80 are transferred to the base.

Turning then to tray assembly 30, it can be seen that tray base 34 slidingly translates on base assembly 20, and is held in position with respect thereto by guides 32a and 32b. To facilitate precision cutting of a cake or other consumable article placed on tray assembly 30, a tray cake holder 36 is provided with a recess for round cakes and an abutment for tray-type cakes. Handle 38 provides a user with the means for conveniently translating tray assembly 30.

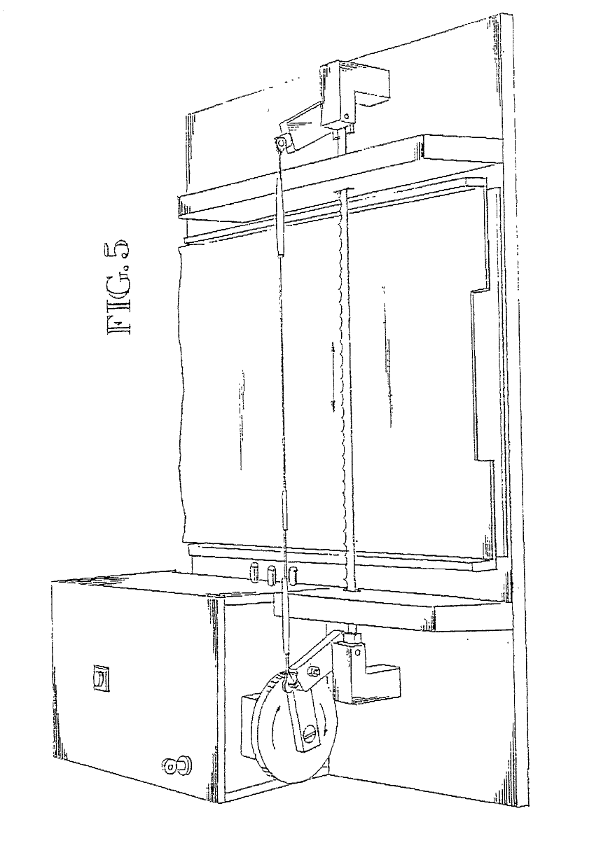

Referring next to FIG. 2, drive assembly 40 will be described. Drive assembly 40 includes motor 42 and bearing housing 44. Motive force from motor 42 is transmitted to saw assembly 80 via a crank wheel or eccentric wheel and connecting rod arrangement. Specifically, drive shaft 46 frictionally engages drive pulley 48 which in turn imparts rotation to driven pulley 50 via drive belt 54, wherein driven pulley 50 is rotationally disposed in bearing housing 44. A plurality of drive pins 52 engage complementary drive pin recesses 57 (see FIG. 4) formed in half coupling 56. An axial bore formed in half coupling 56 is sized to receive reduced diameter portion 64 of crank wheel 62. Rotational motion of half coupling 56 is transferred to crank wheel 62 by way of a frictional fit and roll pin 58, which extends through bore radial 60 formed in half coupling 56 and radial bore 66 formed in reduced diameter portion 64 of crank wheel 62. In turn, main portion 68 of crank wheel 62 rotationally resides in bearing block 26.

Offset threaded bore 70 of crank wheel 62 is sized to receive a shoulder bolt 76, which provides the means whereby connecting rod 72 is linked to crank wheel 62. Another shoulder bolt 76 engages a threaded recess formed in leg 84a of saw assembly 80. By utilizing this configuration, rotational motion from motor 42 is translated into reciprocating motion for saw assembly 80.

Returning to FIG. 1, it can be seen that saw assembly 80 include spanning or web portion 82, legs 84a and 84b and a plurality of bearing shafts 88. Each bearing shaft 88, which is preferably formed from machined stainless steel or other high strength, low wear material, is sized to fit in each bore 28 (see FIG. 2) disposed in bearing blocks 22a and 22b. Because a rigid frame assembly is utilized, distortions and loads resulting from operation of the slicer are primarily retained in saw assembly 80, or are transferred to bearing blocks 22a and 22b as lateral loads, which are particularly suited to addressing such forces.

While the use of a rigid saw assembly achieves many of the objectives of the invention, it is still necessary to provide means for tensioning the saw blade in the assembly. To this end and with reference to FIG. 3, a blade tensioning assembly 90 is utilized. Blade tensioning assembly 90 includes the formation of recess 92 and orthogonal recess 94. Disposed in these recesses are threaded collar with pin 98 and threaded bolt 96. The pin extending from threaded collar 98 engages a hole formed in the saw blade while the threaded portion of threaded collar 98 receives bolt 96 substantially as shown. By rotating either clockwise or counter-clockwise bolt 96, translation of threaded collar 98 is achieved, thereby modifying the tension presented to the saw blade.

Finally, to prevent unintended elevation or declination of a cake or other product being sliced, a plurality of weighted rollers 14 are employed. In particular, and referring again to FIG. 1, each roller assembly comprises weighted roller 14 linked to block 18 by arm 16. The plurality of weighted rollers are located and securely affixed to an internal surface of cover 12. By utilizing weighted rollers, more complex configurations such as spring bias rollers can be avoided. Depending upon the nature of the cake being sliced, a plurality of covers 12 can be utilized, differing only in that the mass of the rollers 14 are modified, insuring that only force necessary to prevent poor slicing qualities are present.

What is claimed is:

1. A food slicer comprising:
a saw assembly including a frame and saw blade attached to the frame;
a base assembly including a bearing block operable to permit linear reciprocating movement of the saw blade and to support the frame as the saw blade moves; and
a drive assembly attached to the base assembly and operable to move the saw blade in a reciprocating linear motion.

2. The food slicer of claim 1 wherein:
the bearing block has a bore, and
the saw assembly includes a leg having a bearing shaft insertable into the bore and sized such that, as the saw blade moves, the bearing shaft of the leg moves relative to the bearing block.

3. The food slicer of claim 1 wherein the saw blade assembly includes a frame having two opposing legs and wherein one end of the saw blade is attached to one of the legs and the other end of the saw blade is attached to the other leg.

4. The food slicer of claim 1 wherein:
the base assembly includes two bearing blocks, each block having a bore,
the saw blade assembly includes a frame having two opposing legs, each leg having a bearing shaft insertable into a respective bore and sized such that, as the saw blade moves, the bearing shafts of the legs move relative to the bearing blocks, and
one end of the saw blade is attached to one of the legs and the other end of the saw blade is attached to the other leg.

5. The food slicer of claim 1 wherein the saw assembly includes a blade tensioner operable to modify the tension of the saw blade.

6. The food slicer of claim 1 wherein the drive assembly includes a motor operable to move the saw blade.

7. The food slicer of claim 1 wherein the drive assembly includes a motor and a half coupling operable to attach the motor to the saw assembly.

8. The food slicer of claim 1 wherein the drive assembly includes:
a motor,
a driven pulley having a plurality of drive pins and operatively attached to the motor, and
a half coupling having a plurality of drive-pin recesses sized to receive at least one drive pin, wherein the half coupling is operable to transmit the power of the motor to the saw assembly when the drive pins are inserted in the drive-pin recesses.

9. The food slicer of claim 1 further comprising a tray assembly slidably mounted to the base assembly and movable relative to the saw blade.

10. The food slicer of claim 1 further comprising one or more weighted rollers operable to prevent the item of food being sliced from unintentionally elevating or declining as the item of food is being sliced.

11. The food slicer of claim 1 further comprising a cover removably attached to the base assembly.

12. The food slicer of claim 1 further comprising a cover removably attached to the base assembly and one or more weighted rollers attached to the cover.

13. A method of slicing food comprising:
presenting an item of food to a food slicer;
moving a saw blade supported on the food slicer by a bearing block in a reciprocating linear motion;
slicing the item of food by moving the item of food across the saw blade;

14. The method of claim 13 wherein presenting an item of food includes placing the item of food on a tray assembly and moving the item of food includes moving the tray assembly.

15. The method of claim 13 wherein moving the saw blade includes turning on a motor operable to reciprocate the saw blade.

16. The method of claim 13 further comprising modifying the tension of the saw blade.

17. The method of claim 13 further comprising retaining the item of food on the slicer to prevent unintentional elevation or declination of the item of food prior to slicing the item of food.
